(19) United States
(12) Patent Application Publication
(10) Pub. No.: US 2026/0145349 A1
(43) Pub. Date: May 28, 2026

(54) WAX WIRE APPARATUS AND RELATED SYSTEMS AND METHODS

(71) Applicant: Nhi Pham Enterprise, LLC, Houston, TX (US)

(72) Inventor: Danh Cong Pham, Houston, TX (US)

(73) Assignee: Nhi Pham Enterprise, LLC, Houston, TX (US)

(21) Appl. No.: 19/397,890

(22) Filed: Nov. 22, 2025

Related U.S. Application Data
(60) Provisional application No. 63/724,072, filed on Nov. 22, 2024.

(51) Int. Cl. B26D 1/553

(52) U.S. Cl. CPC B26D 1/553

(57) ABSTRACT

Wax wire devices, systems and methods are disclosed for facilitating removal of hardened paraffin wax from a bulk container. A wax wire apparatus may include a wax container, a horizontal slicing wire loop secured within the wax container, a portion of the horizontal slicing wire loop being disposed in a generally horizontal plane, and a vertical slicing wire loop secured within the wax container, a portion of the wire loop being disposed in a generally vertical plane. Liquid wax may be poured into the wax container and allowed to harden. Pulling the horizontal slicing wire loop out of the hardened wax will create a horizontal slice through the hardened wax. Pulling the vertical slicing wire loop out of the hardened wax will create a vertical slice through the hardened wax, which may be in a vertical plane generally perpendicular to a horizontal plane corresponding to the horizontal slice.

### RELATED APPLICATIONS

This application claims the benefit of U.S. Provisional Application No. 63/724,072, filed Nov. 22, 2024, the contents of which are fully incorporated herein by reference.

### BACKGROUND OF THE INVENTIONS

### 1. Field of the Inventions

The present inventions generally pertain to paraffin wax, and more particularly to methods and systems for removing hardened paraffin wax from a container.

### 2. Description Of The Related Art

It is known that paraffin wax is used in beauty salons for cosmetic purposes to treat a person's skin. The paraffin wax is typically packaged in hand-held plastic packages that are delivered to the salon for use. The packaged paraffin wax is in a solid form, much like the consistency of a candle. When the paraffin wax is needed, the salon will cut off the plastic packaging, and then place the wax into a warmer where it is warmed into a liquid-like or flowable consistency. The wax can then be easily dipped out of the warmer and applied to the customer's skin in a known manner.

It has been determined that it would be more efficient and economical to deliver the paraffin wax to beauty salons in larger, bulk containers, such as a container around the size of a five-gallon bucket, for example. Proceeding in this fashion, however, creates a problem to be solved, namely, how to extract the hardened paraffin wax from the bulk container. The present inventions as discussed hereinbelow have been developed to address and solve this problem.

### SUMMARY OF THE INVENTIONS

In one aspect, the present inventions may include a wax wire apparatus comprising: a wax container; a horizontal slicing wire loop secured within the wax container, a portion of the horizontal slicing wire loop being disposed in a generally horizontal plane; and a vertical slicing wire loop secured within the wax container, a portion of the wire loop being disposed in a generally vertical plane. Another feature of this aspect of the present inventions may be that the apparatus further includes a mass of hardened wax within the wax container, the mass of hardened wax including a front surface, a right surface, a rear surface, a left surface, a bottom surface, and a top surface, a portion of the horizontal slicing wire loop being disposed around the front surface, right surface, rear surface and left surface, and a portion of the vertical slicing wire loop being disposed around the front surface, the top surface, the rear surface and the bottom surface. Another feature of this aspect of the present inventions may be that the wax container includes a front wall, a right wall, a rear wall, a left wall, and a lower surface, and the wax wire apparatus further includes a first wire side clip on an inner surface of the front wall, a second wire side clip on an inner surface of the right wall, a third wire side clip on an inner surface of the rear wall, and a fourth wire side clip on an inner surface of the left wall, wherein the horizontal slicing wire loop is secured adjacent the inner surfaces of the front, right, rear and left walls by the first, second, third and fourth wire side clips. Another feature of this aspect of the present inventions may be that each wire side clip includes an upper body member and a lower body member, a lower surface of the upper body member including a lower extension rail, an upper surface of the lower body member including an upper extension rail, the lower extension rail and the upper extension rail defining a longitudinal slot. Another feature of this aspect of the present inventions may be that each wire side clip includes a central channel defined by a rear surface of the lower extension rail, a rear surface of the upper extension rail, a lower surface of the upper body member, and an upper surface of the lower body member. Another feature of this aspect of the present inventions may be that the apparatus may further include a first hook clip on the inner surface of one of the front wall, the right wall, the rear wall, and the left wall, wherein the vertical slicing wire loop is hooked over the first hook clip. Another feature of this aspect of the present inventions may be that the apparatus may further include a wire funnel on the inner surface of the right wall, and the horizontal wire loop is disposed through the wire funnel. Another feature of this aspect of the present inventions may be that the apparatus may further include a cross tie positioned on a floor surface of the wax container, the cross tie including at least one wire channel, the vertical slicing wire loop being disposed in the wire channel.

In another aspect, the present inventions may include a wax wire apparatus comprising: a wax container; a horizontal slicing wire loop secured within the wax container, a portion of the horizontal slicing wire loop being disposed in a generally horizontal plane; a vertical slicing wire loop secured within the wax container, a portion of the wire loop being disposed in a generally vertical plane; and a mass of hardened wax within the wax container, the mass of hardened wax including a front surface, a right surface, a rear surface, a left surface, a bottom surface, and a top surface, a portion of the horizontal slicing wire loop being disposed around the front surface, right surface, rear surface and left surface, and a portion of the vertical slicing wire loop being disposed around the front surface, the top surface, the rear surface and the bottom surface. Another feature of this aspect of the present inventions may be that the wax container may further include a front wall, a right wall, a rear wall, a left wall, and a lower surface, and the wax wire apparatus further includes a first wire side clip on an inner surface of the front wall, a second wire side clip on an inner surface of the right wall, a third wire side clip on an inner surface of the rear wall, and a fourth wire side clip on an inner surface of the left wall, wherein the horizontal slicing wire loop is secured adjacent the inner surfaces of the front, right, rear and left walls by the first, second, third and fourth wire side clips. Another feature of this aspect of the present inventions may be that each wire side clip includes an upper body member and a lower body member, a lower surface of the upper body member including a lower extension rail, an upper surface of the lower body member including an upper extension rail, the lower extension rail and the upper extension rail defining a longitudinal slot. Another feature of this aspect of the present inventions may be that each wire side clip includes a central channel defined by a rear surface of the lower extension rail, a rear surface of the upper extension rail, a lower surface of the upper body member, and an upper surface of the lower body member. Another feature of this aspect of the present inventions may be that the apparatus may further include a first hook clip on the inner surface of one of the front wall, the right wall, the rear wall, and the left wall, wherein the vertical slicing wire loop is hooked over the first hook clip. Another feature of this aspect of the present inventions may be that the apparatus may further include a wire funnel on the inner surface of the right wall, and the horizontal wire loop is disposed through the wire funnel. Another feature of this aspect of the present inventions may be that the apparatus may further include a cross tie positioned on a floor surface of the wax container, the cross tie including at least one wire channel, the vertical slicing wire loop being disposed in the wire channel.

In another aspect, the present inventions may include a wax wire apparatus comprising: a wax container; a lower horizontal slicing wire loop secured within the wax container, a portion of the lower horizontal slicing wire loop being disposed in a first generally horizontal plane; an upper horizontal slicing wire loop secured within the wax container, a portion of the upper horizontal slicing wire loop being disposed in a second generally horizontal plane, the second generally horizontal plane being above and spaced apart from the first generally horizontal plane; a front-to-back vertical slicing wire loop secured within the wax container, a portion of the front-to-back vertical slicing wire loop being disposed in a first generally vertical plane; and a side-to-side vertical slicing wire loop secured within the wax container, a portion of the side-to-side vertical slicing wire loop being disposed in a second generally vertical plane. Another feature of this aspect of the present inventions may be that the first generally vertical plane is generally perpendicular to the second generally vertical plane. Another feature of this aspect of the present inventions may be that the apparatus may further include a mass of hardened wax within the wax container, the mass of hardened wax including a front surface, a right surface, a rear surface, a left surface, a bottom surface, and a top surface, a portion of the upper horizontal slicing wire loop and the lower horizontal slicing wire loop being disposed around the front surface, right surface, rear surface and left surface, a portion of the front-to-back vertical slicing wire loop being disposed around the front surface, the top surface, the rear surface and the bottom surface, and a portion of the side-to-side vertical slicing wire loop being disposed around the left surface, the bottom surface, the right surface, and the top surface. Another feature of this aspect of the present inventions may be that the apparatus may further include an upper wire funnel and a lower wire funnel, the upper wire funnel being positioned on the inner surface of the right wall, the lower wire funnel being positioned on the inner surface of the right wall below the upper wire funnel, the upper horizontal slicing wire loop being disposed through the upper wire funnel, and the lower horizontal slicing wire loop being disposed through the lower wire funnel and the upper wire funnel. Another feature of this aspect of the present inventions may be that the apparatus may further include a first cross tie and a second cross tie, each of the first and second cross ties being positioned on a floor surface of the wax container and including a front-to-back wire channel and a side-to-side wire channel, the front-to-back vertical slicing wire loop being disposed in the front-to-back wire channel, and the side-to-side vertical slicing wire loop being disposed in the side-to-side wire channel.

Other features, aspects and advantages of the present inventions will become apparent from the following discussion and detailed description.

### BRIEF DESCRIPTION OF THE DRAWINGS

FIG. 1 is a perspective view of a specific embodiment of the interior of a wax container looking from the front right of the container and with a specific embodiment of various structures positioned to guide, position, and/or support various wire loops to be used in slicing hardened wax in the container.

FIG. 2 is a perspective view of a specific embodiment of the interior of the wax container shown in FIG. 1, but from a different perspective, looking from the back right of the wax container.

FIG. 3 is a perspective view of a specific embodiment of a hook clip in accordance with one aspect of the present inventions.

FIG. 4 is a side view of the hook clip shown in FIG. 3.

FIG. 5 is a front view of the hook clip shown in FIGS. 3 and 4.

FIG. 6 is a perspective view of a specific embodiment of a cross tie in accordance with one aspect of the present inventions.

FIG. 7 is a top view of the cross tie shown in FIG. 6.

FIG. 8 is a side view of the cross tie shown in FIGS. 6 and 7.

FIG. 9 is a perspective view of specific embodiment of a wire funnel in accordance with one aspect of the present inventions.

FIG. 10 is a front view of the wire funnel shown in FIG. 9.

FIG. 11 is a side view of the wire funnel shown in FIGS. 9 and 10.

FIG. 12 is a rear view of the wire funnel shown in FIGS. 9-11.

FIG. 13 is another view of FIG. 1, but now including a series of wires loops installed therein.

FIG. 14 is another view of FIG. 2, but now including the series of wire loops shown in FIG. 13.

FIG. 15 is another view of FIG. 13 with the wax container in the process of being filled with liquid wax.

FIG. 16 is another view of FIG. 15 after the wax container has been filled with liquid wax and it has hardened.

FIG. 17 is a perspective view of a specific embodiment of a removal tool in accordance with one aspect of the present inventions.

FIG. 18 is an enlarged view of the tip of the removal tool shown in FIG. 17.

FIG. 18A is a side view of the tip of the removal tool shown in FIG. 18.

FIG. 19 is another view of FIG. 16 showing the removal tool from FIG. 17 being used to pull upwardly on horizontal slicing wire loops, which will make two horizontal slices through the hardened wax in the wax container when they are completely removed from the wax container.

FIG. 20 is another view of FIG. 19 after the horizontal slicing wire loops have been removed from the wax container and the removal tool is being used to lift and start pulling two vertical slicing wire loops.

FIG. 21 is another view of FIG. 20 after the vertical slicing wire loops shown in FIG. 20 have been removed from the wax container and the removal tool is being used to lift and start pulling a separate set of two vertical slicing wire loops.

FIG. 22 is another view of FIG. 21 after both sets of vertical slicing wire loops shown in FIGS. 20 and 21 have been removed from the wax container.

FIG. 23 is another view of FIG. 22 and showing a removal tool being used to lift and remove a wax block from the wax container.

FIG. 24 is a perspective view of a specific embodiment of a wire side clip in accordance with one aspect of the present inventions.

FIG. 25 is a front view of the wire side clip shown in FIG. 24.

FIG. 26 is a bottom view of the wire side clip shown in FIGS. 24 and 25.

FIG. 27 is a side view of the wire side clip shown in FIGS. 24-26.

While the inventions will be described in connection with the preferred embodiments, it will be understood that the scope of protection is not intended to limit the inventions to those embodiments. On the contrary, the scope of protection is intended to cover all alternatives, modifications, and equivalents as may be included within the spirit and scope of the inventions as defined by the appended claims.

### DETAILED DESCRIPTION OF THE INVENTION

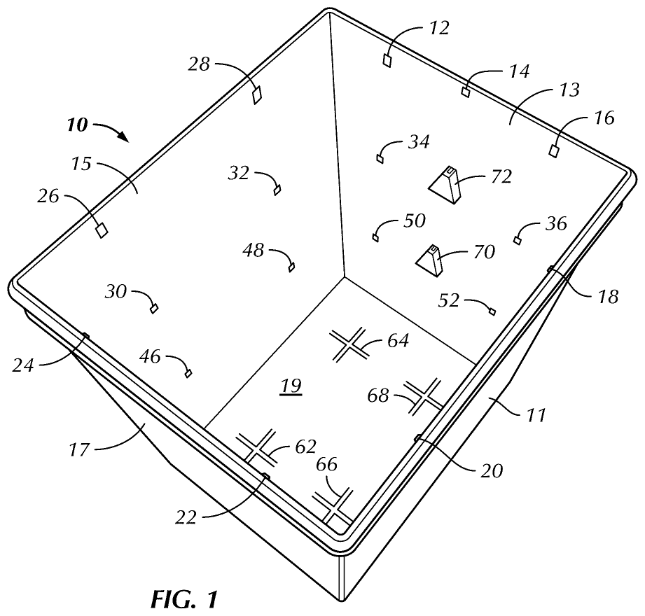

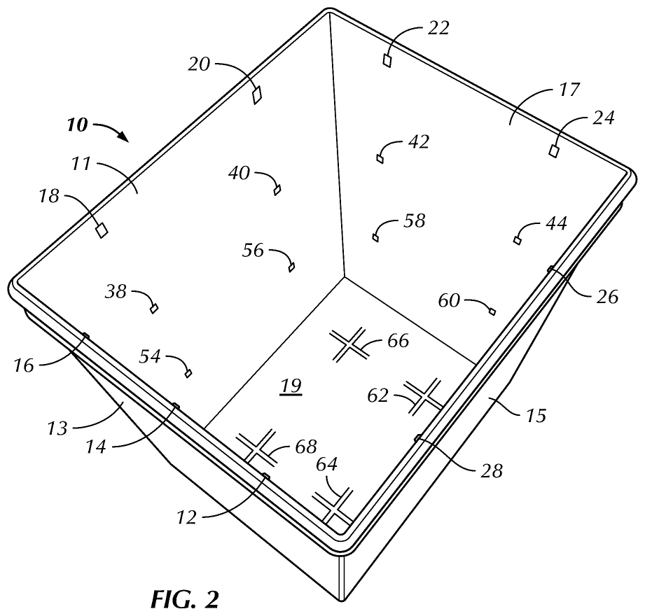

Referring to the drawings in detail, wherein like numerals denote identical elements throughout the several views, and referring initially to FIG. 1, there is shown a perspective view of the interior a specific embodiment of a wax container 10 looking from the front left of the wax container 10. FIG. 2 is a perspective view of the same wax container 10, only looking from the back right corner of the wax container 10. The wax container 10 may include a front wall 11, a right wall 13, a rear wall 15, a left wall 17, and a floor surface 19.

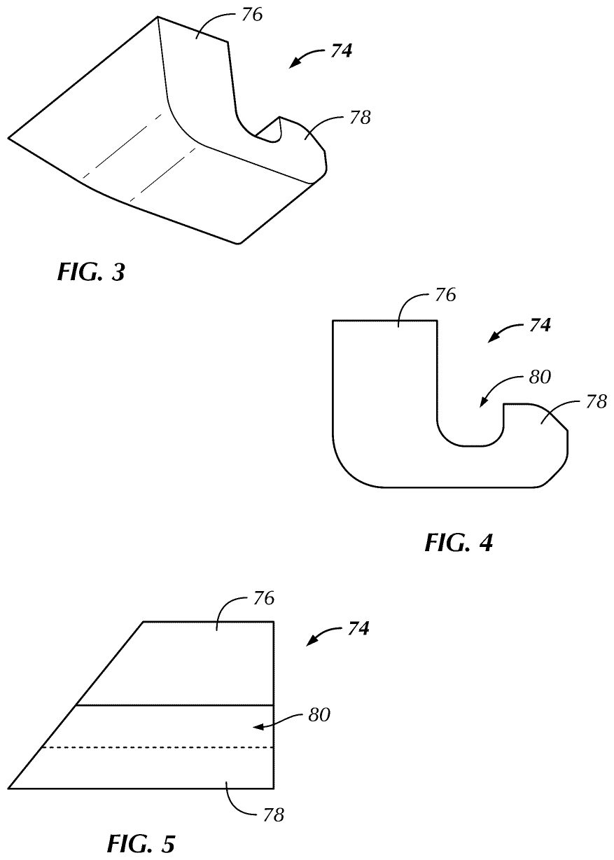

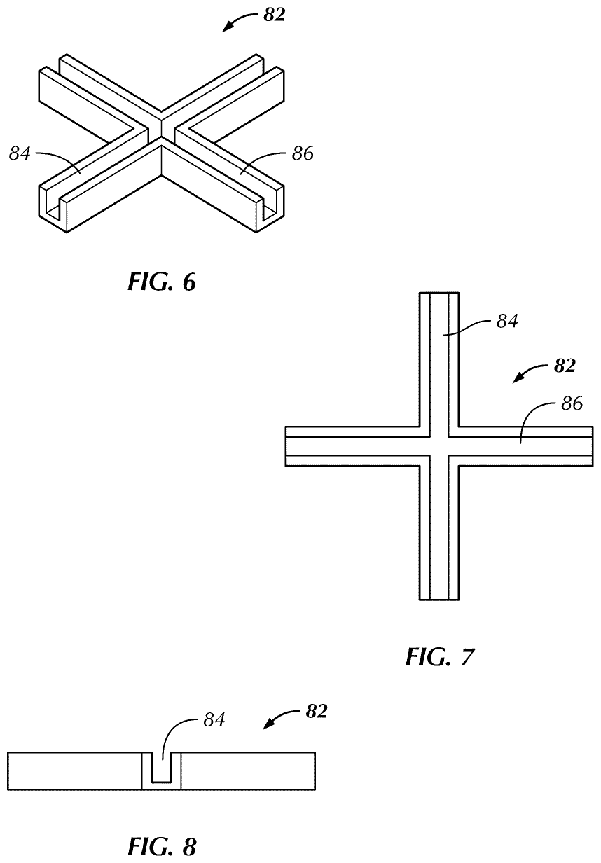

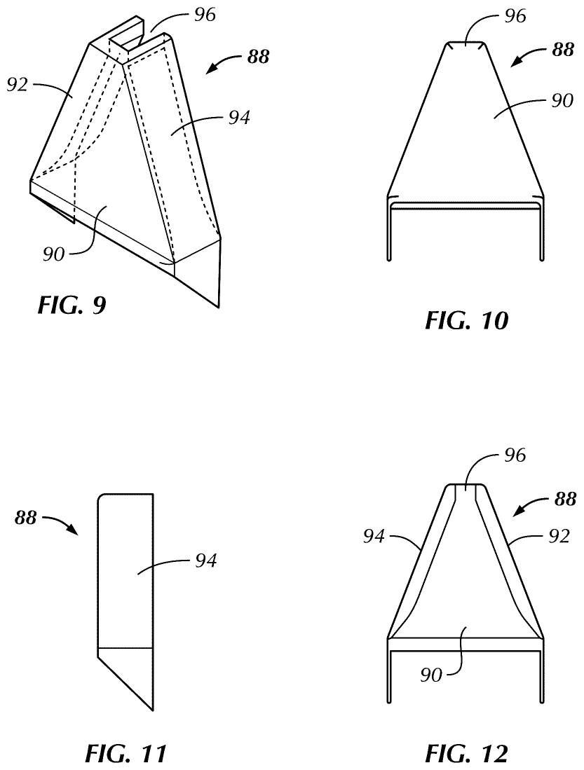

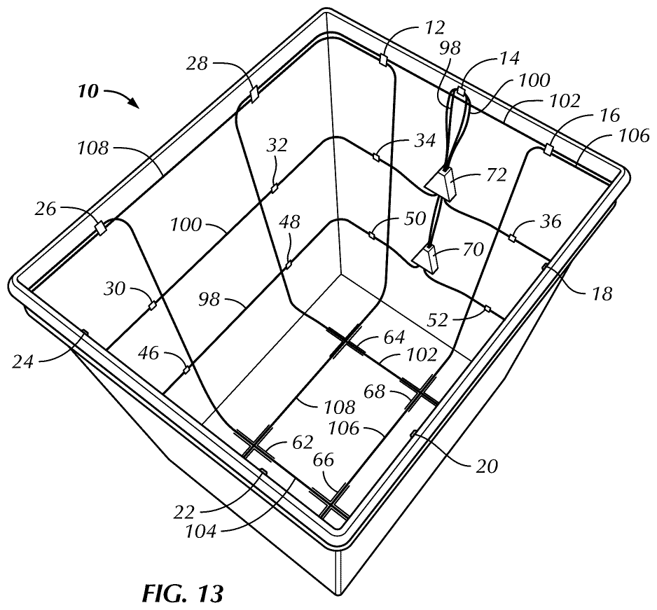

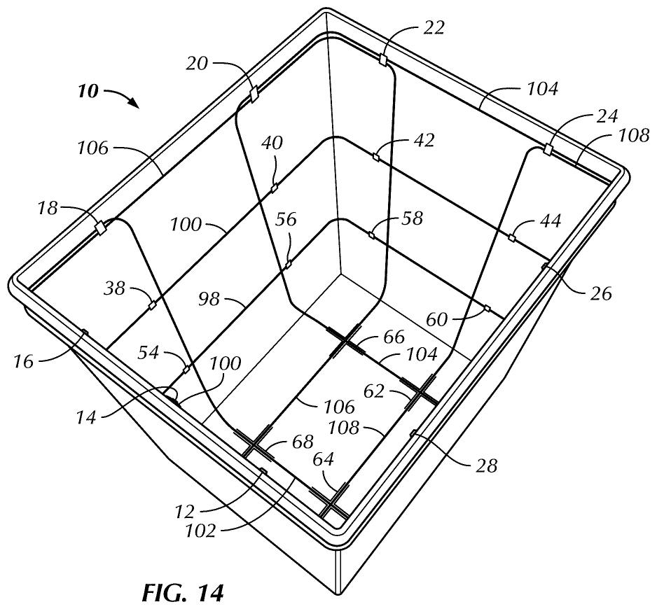

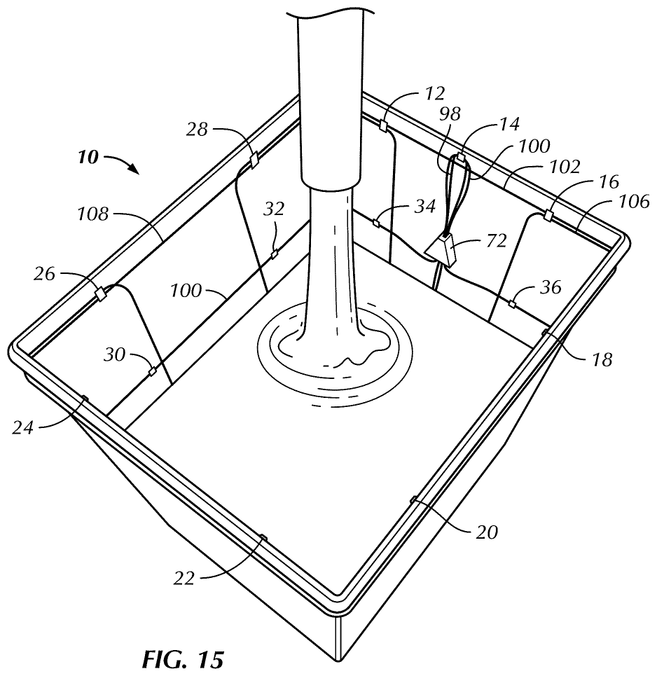

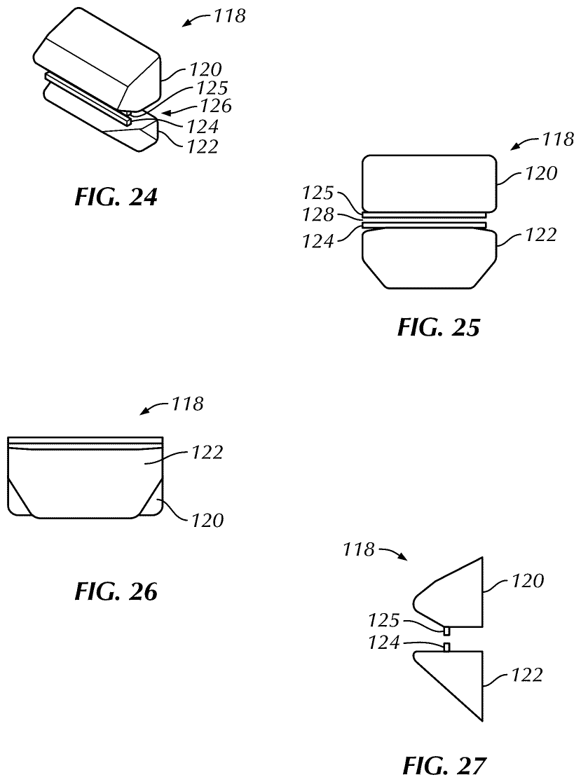

There are a number of structures on the interior surfaces of the wax container 10, including a number hook clips 74 (see FIGS. 3-5, and items 12, 14, 16, 18, 20, 22, 24, 26 and 28 shown in FIGS. 1 and 2), a number of cross ties 82 (see FIGS. 6-8, and items 62, 64, 66 and 68 in FIGS. 1 and 2), a number of wire funnels 88 (see FIGS. 9-12, and items 70 and 72 shown in FIG. 1), and a number of wire side clips 118 (see FIGS. 24-27, and items 30, 32, 34, 36, 38, 40, 42, 44, 46, 48, 50, 52, 54, 56, 58 and 60 in FIGS. 1 and 2). In a specific embodiment, these items may be formed as part of the wax container 10 during the manufacturing molding process, such as by injection molding. It is noted that the present inventions are not limited to any particular number of the structural items discussed in this paragraph, but instead are intended to encompass various numbers, collections and/or wall positions of the components listed in this paragraph. In addition, while the wax container 10 depicted in the drawings has a generally rectangular shape, the present inventions are not limited to any particular shape of wax container 10, but instead are intended to encompass any shape of wax container 10.

Referring to FIGS. 3-5, a specific embodiment of a hook clip 74 is shown, and may include a body member 76 and a hook member 78. A longitudinal wire recess 80 is defined between a front surface of the body member 76 and a rear surface of the hook member 78. With reference to FIGS. 1 and 2, in a specific embodiment, the right wall 13 of the wax container 10 may include a first hook clip 12, a second hook clip 14, and a third hook clip 16. In a specific embodiment, the front wall 11 of the wax container 10 may include a fourth hook clip 18 and a fifth hook clip 20. In a specific embodiment, the left wall 17 of the wax container 10 may include a sixth hook clip 22 and a seventh hook clip 24. In a specific embodiment, the rear wall 15 of the wax container 10 may include an eighth hook clip 26 and a ninth hook clip 28. In a specific embodiment, each of these hooks clips may be positioned near an upper peripheral edge of the wax container 10, and may be spaced down from the upper peripheral edge by the same distance so as to be in general alignment with each with (i.e., generally in the same plane). In a specific embodiment, the hook clips may be positioned such that the wire recess 80 of the hook clip 74 is generally parallel to the upper peripheral edge of the wax container 10 and/or the floor surface 19; another way of saying this is that the hook members 78 are facing upwardly. As will be more fully discussed below, the purpose of these hook clips is to hold upper portions of vertical slicing wire loops (the loops are draped over the hook members 78 and rest in the wire recesses 80) during shipment to allow for nesting of wax container during the shipping process.

Referring to FIGS. 6-8, a specific embodiment of a cross tie 82 is shown, and may include a cross-shaped body member defining a first wire channel 84 extending from one side of a first cross member to a second side of the first cross member, and a second wire channel 86 extending from one side of a second cross member to a second side of the second cross member. The first and second cross members, and associated first and second wire channels 84 and 86, may be disposed in generally perpendicular relationship to each other.

With reference to FIGS. 1 and 2, in a specific embodiment, the floor surface 19 of the wax container 10 may include a first cross tie 62, a second cross tie 64, a third cross tie 66 and a fourth cross tie 68. In a specific embodiment, the first cross tie 62 and the second cross tie 64 may be in general alignment with each other, with corresponding wire channels in generally parallel relationship to the rear wall 15 and in general alignment with each other. In a specific embodiment, the second cross tie 64 and the fourth cross tie 68 may be in general alignment with each other, with corresponding wire channels in generally parallel relationship to the right wall 13 and in general alignment with each other. In a specific embodiment, the third cross tie 66 and the fourth cross tie 68 may be in general alignment with each other, with corresponding wire channels in generally parallel relationship to the front wall 11 and in general alignment with each other. In a specific embodiment, the third cross tie 66 and the first cross tie 62 may be in general alignment with each other, with corresponding wire channels in generally parallel relationship to the left wall 17 and in general alignment with each other. As will be more fully discussed below, the purpose of these cross ties is to hold the lower portions of vertical slicing wire loops in proper position along the floor surface 19 of the wax container 10 before liquid wax is poured into the wax container 10.

Referring to FIGS. 9-12, a specific embodiment of a wire funnel 88 is shown, and may include a front wall 90, a left side wall 92 extending rearwardly in generally perpendicular relationship to the front wall 90 and along a left edge of the front wall 90, and a right side wall 94 extending rearwardly in generally perpendicular relationship to the front wall 90 and along a right edge of the front wall 90. In a specific embodiment, the front wall 90 may have a generally triangular shape. An upper end of the front panel 90, an upper end of the left side wall 92 and an upper end of the right side wall 94 may define a funnel slot 96. With reference to FIG. 1, in a specific embodiment, the right wall 13 of the wax container 10 may include a first wall funnel 70 and a second wall funnel 72. In a specific embodiment, the first wall funnel 70 may be positioned directly below and in general alignment with the second wall funnel 72, and may be positioned with their respective funnel slots 96 pointed upwardly. As will be more fully discussed below, horizontal slicing wire loops are routed into the wire funnels 70 and 72 and up through the funnel slots 96, and then looped over the hook clip 14 shown for example in FIG. 1.

Referring to FIGS. 24-27, a specific embodiment of a wire side clip 118 is shown, and may include an upper body member 120 and a lower body member 122. In a specific embodiment, the upper body member 120 may include a lower extension rail 125, and the lower body member 122 may include an upper extension rail 124. In a specific embodiment, the upper and lower body members 120 and 122 (which are actually two separate structures positioned adjacent each other) may be formed as part of the walls of the wax container 10 and positioned such that the lower extension rail 125 and the upper extension rail 124 are spaced apart by a small distance to define a longitudinal slot 128. A central channel 126 is defined below the lower and upper extension rails 124 and 125 and between the upper and lower body members 120 and 122. As will be more fully discussed below, the width of the longitudinal slot 128 is sized to allow horizontal slicing wire loops to fit through the slot 128 but also to allow the upper and lower extension rails 124 and 125 to retain the wire loops within the central channels 126.

With reference to FIGS. 1 and 2, in a specific embodiment, the rear wall 15 of the wax container 10 may include a first wire side clip 30 and a second wire side clip 32. In a specific embodiment, the right wall 13 of the wax container 10 may include a third wire side clip 34 and a fourth wire side clip 36. In a specific embodiment, the front wall 11 of the wax container 10 may include a fifth wire side clip 38 and a sixth wire side clip 40. In a specific embodiment, the left wall 17 of the wax container 10 may include a seventh wire side clip 42 and an eighth wire side clip 44. In a specific embodiment, each of these wire side clips 30-44 may be positioned below the hook clips 12-28. In a specific embodiment, each of these wire side clips 30-44 may be in general alignment with each other around the periphery of the wax container 10. In a specific embodiment, each of these wire side clips 30-44 may lie in generally the same plane, which may be a generally horizontal plane. In a specific embodiment, the wire side clips 30-44 may be formed into the interior surfaces of the walls of the wax container 10 such that the central channels 126 of the wire side clips 118 are generally parallel to the upper peripheral edge of the wax container 10 and/or floor surface 19. As will be more fully discussed below, these wire side clips function to guide and properly position an upper horizontal slicing wire loop.

Referring now to FIGS. 13 and 14, the various horizonal and vertical slicing wire loops mentioned above will now be discussed and described in more detail. In a specific embodiment, the wax container 10 may include a lower horizontal slicing wire loop 98, an upper horizontal slicing wire loop 100, a first front-to-back vertical slicing wire loop 102, a second front-to-back vertical slicing loop wire 104, a first side-to-side vertical slicing wire loop 106, and a second side-to-side vertical slicing wire loop 108.

In a specific embodiment, with reference to FIGS. 13 and 14, the lower horizontal slicing wire loop 98 is positioned in the central channels 126 of the wire side clips 46-60 and then fed up through the funnel slots 96 on the wire funnels 70 and 72. An upper folded end of the lower horizontal slicing wire loop 98 is then placed over the central hook clip 14.

In a specific embodiment, with reference to FIGS. 13 and 14, the upper horizontal slicing wire loop 100 is positioned in the central channels 126 of the wire side clips 30-44 and then fed up through the funnel slot 96 on the upper wire funnel 72. An upper folded end of the upper horizontal slicing wire loop 100 is then placed over the central hook clip 14.

In a specific embodiment, with reference to FIGS. 13 and 14, the first front-to-back vertical slicing wire loop 102 is positioned in corresponding aligned wire channels 84/86 in the second cross tie 64 and the fourth cross tie 68, and the upper portion of the wire loop 102 is placed over the hook clips 28, 12, 16, and 18.

In a specific embodiment, with reference to FIGS. 13 and 14, the second front-to-back vertical slicing wire loop 104 is positioned in corresponding aligned wire channels 84/86 in the first cross tie 62 and the third cross tie 66, and the upper portion of the wire loop 104 is placed over the hook clips 20, 22, 24, and 26.

In a specific embodiment, with reference to FIGS. 13 and 14, the first side-to-side vertical slicing wire loop 106 is positioned in corresponding aligned wire channels 84/86 in the third cross tie 66 and the fourth cross tie 68, and the upper portion of the wire loop 106 is placed over the hook clips 16, 18, 20, and 22.

In a specific embodiment, with reference to FIGS. 13 and 14, the second side-to-side vertical slicing wire loop 108 is positioned in corresponding aligned wire channels 84/86 in the first cross tie 62 and the second cross tie 64, and the upper portion of the wire loop 108 is placed over the hook clips 24, 26, 28, and 12.

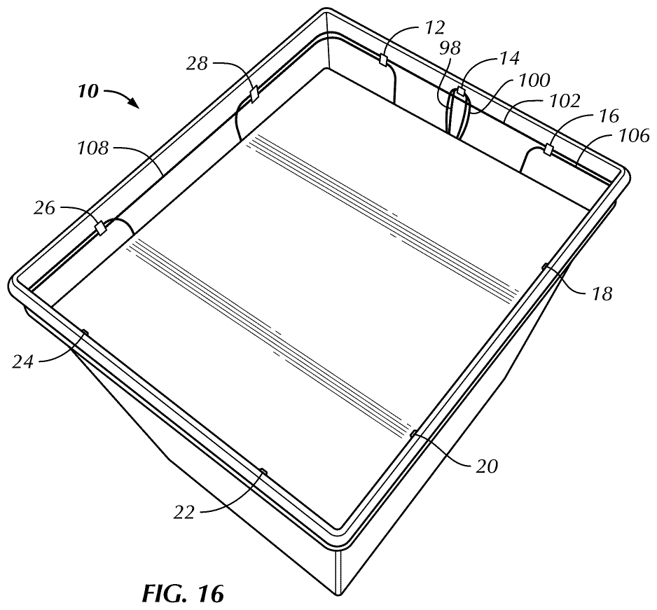

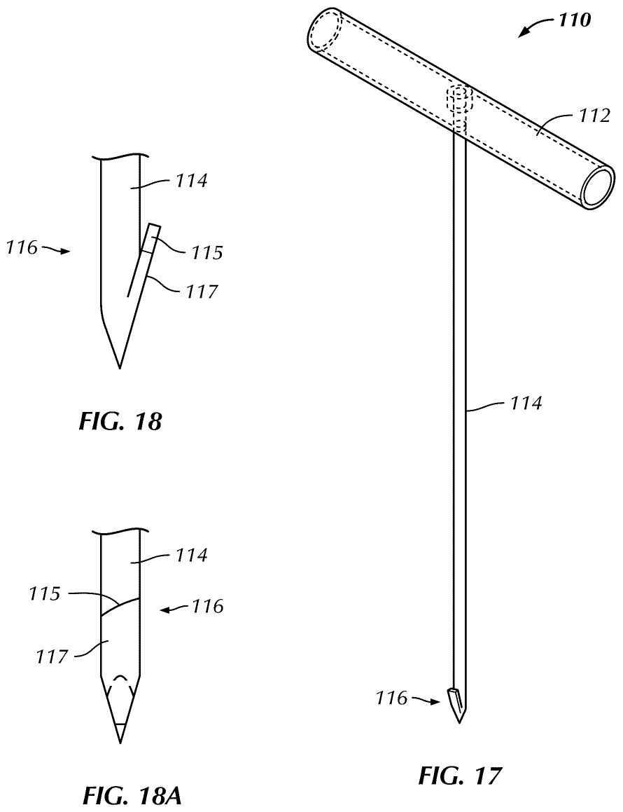

In use, as shown in FIG. 15, liquid wax is poured into the wax container, and, as shown in FIG. 16, filled up to a level below the hook clips 12, 14, 16, 18, 20, 22, 24, 26 and 28. The liquid wax is then allowed to harden. Next, a removal tool 110 is used to pull the various wire loops out of the hardened wax. As shown in FIGS. 17, 18 and 18A, the removal tool 110 may include a handle 112 and a longitudinal rod 114. A lower end of the longitudinal rod 114 may include a tip 116. The tip 116 may include an upwardly angled blade 117 having an upper curved surface 115, which facilitates engagement of the removal tool 110 when used to stab and remove sliced blocks of hardened wax from the wax container 10.

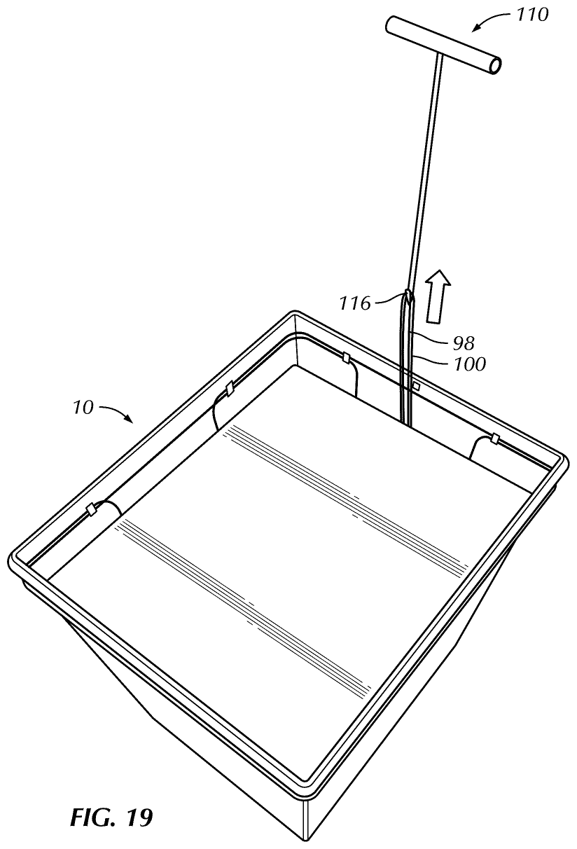

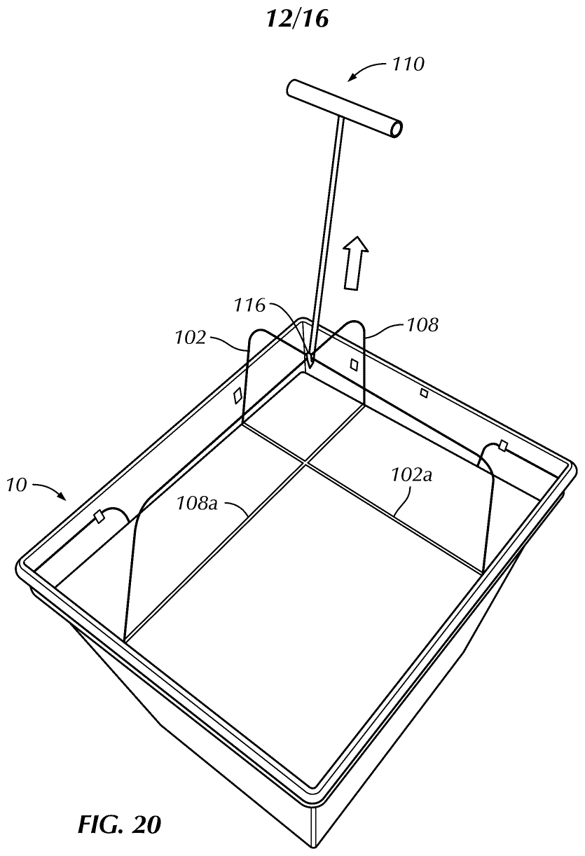

In a specific embodiment, with reference to FIG. 19, the removal tool 110 may first be used to hook the upper folded ends of the horizontal slicing wire loops 98 and 100, and then pull them upwardly and out of the hardened wax. The process of removing these horizontal wire loops will make two generally horizontal slices in the mass of hardened wax in the wax container 10.

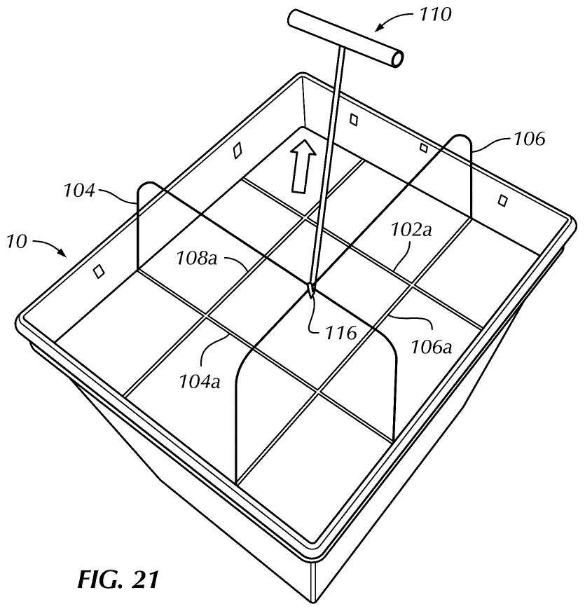

Next, in a specific embodiment, with reference to FIG. 20, the removal tool 110 may be used to hook the first front-to-back vertical slicing wire loop 102 (i.e., the one on the right side) and the second side-to-side vertical slicing wire loop 108 (i.e., the one on the rear side). Then the removal tool 110 is used to pull up on those wire loops 102 and 108 until they are removed from the hardened mass of wax inside the wax container 10. The process of removing these two loops 102 and 108 will make two generally vertical slices, as indicated by slice lines 102a and 108a in FIG. 21.

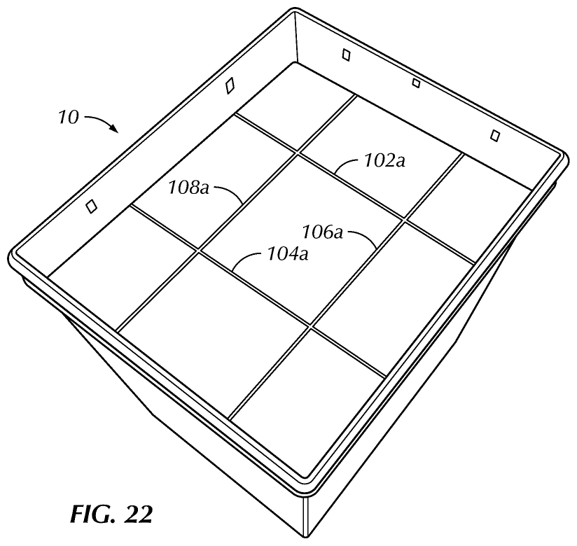

Next, in a specific embodiment, with reference to FIG. 21, the removal tool 110 may be used to hook the second front-to-back vertical slicing wire loop 104 (i.e., the one on the left side) and the first side-to-side vertical slicing wire loop 106 (i.e., the one on the front side). Then the removal tool 110 is used to pull up on those wire loops 104 and 106 until they are removed from the hardened mass of wax inside the wax container 10. The process of removing these two loops 104 and 106 will make two generally vertical slices, as indicated by slice lines 104a and 106a in FIG. 22.

In a specific embodiment, the wire loops 98-108 may be positioned to, when pulled, slice the hardened wax so as to create three horizontal layers of wax blocks, with nine wax blocks in each layer, and six vertical stacks of wax blocks, with nine blocks in each stack, for a total of twenty seven wax blocks. Again, as discussed elsewhere herein, the present inventions are not limited to any particular size of wax container 10, or to any number of slicing wire loops to be installed inside the wax container, and to the creation of any particular number of wax blocks, horizontal layers of wax blocks, and/or vertical stacks of wax blocks.

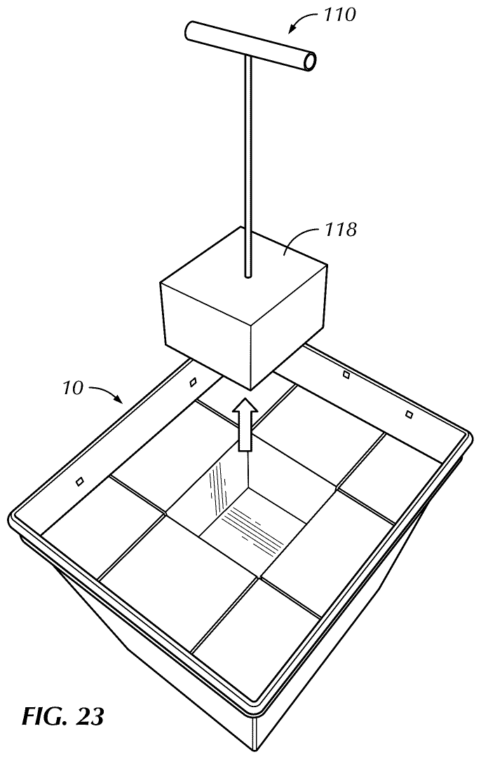

FIG. 22 is a perspective view showing the wax container 10 after the wax has hardened and the various wire loops have been pulled out to create multiple horizontal and vertical slices and create multiple blocks of hardened wax that can be stabbed with the removal tool 110 and then lifted out of the wax container 10. FIG. 23 shows the removal tool 110 being used to remove the top middle wax block 118 from the wax container 10. These blocks can then be used at salons in a known manner by melting them and then using the melted wax for use on their customers.

The present inventions provide numerous advantages over the current state of the art. Using the present inventions is more efficient and results in greater volumes of melted wax available for use in less time and with less work. This allows salons to more quickly and more efficiently serve more customers. Use of the present inventions also results in cost savings to beauty salons. Paraffin wax can be sold in bulk at prices that are far less than current paraffin wax prices for one-pound packages. Using the present inventions also reduces costs in terms of labor and handling.

It is to be understood that the inventions disclosed herein are not limited to the exact details of construction, operation, exact materials, or embodiments shown and described. Although specific embodiments of the inventions have been described, various modifications, alterations, alternative constructions, and equivalents are also encompassed within the scope of the inventions. Although the present inventions may have been described using a particular series of steps, it should be apparent to those skilled in the art that the scope of the present inventions is not limited to the described series of steps. The specification and drawings are, accordingly, to be regarded in an illustrative rather than a restrictive sense. It will be evident that additions, subtractions, deletions, and other modifications and changes may be made thereunto without departing from the broader spirit and scope of the inventions as set forth in the claims set forth below. It should also be understood that relative terms such as “upper” and “lower” and “upwardly” and “downwardly” are simply to provide frame of reference and should not be taken as limiting to any particular orientation. Accordingly, the inventions are therefore to be limited only by the scope of the appended claims. None of the claim language should be interpreted pursuant to 35 U.S.C. 112(f) unless the word “means” is recited in any of the claim language, and then only with respect to any recited “means” limitation.

1. A wax wire apparatus comprising:
a wax container;
a horizontal slicing wire loop secured within the wax container, a portion of the horizontal slicing wire loop being disposed in a generally horizontal plane; and
a vertical slicing wire loop secured within the wax container, a portion of the wire loop being disposed in a generally vertical plane.

2. The wax wire apparatus of claim 1, further including a mass of hardened wax within the wax container, the mass of hardened wax including a front surface, a right surface, a rear surface, a left surface, a bottom surface, and a top surface, a portion of the horizontal slicing wire loop being disposed around the front surface, right surface, rear surface and left surface, and a portion of the vertical slicing wire loop being disposed around the front surface, the top surface, the rear surface and the bottom surface.

3. The wax wire apparatus of claim 1, wherein the wax container includes a front wall, a right wall, a rear wall, a left wall, and a lower surface, and the wax wire apparatus further includes a first wire side clip on an inner surface of the front wall, a second wire side clip on an inner surface of the right wall, a third wire side clip on an inner surface of the rear wall, and a fourth wire side clip on an inner surface of the left wall, wherein the horizontal slicing wire loop is secured adjacent the inner surfaces of the front, right, rear and left walls by the first, second, third and fourth wire side clips.

4. The wax wire apparatus of claim 3, wherein each wire side clip includes an upper body member and a lower body member, a lower surface of the upper body member including a lower extension rail, an upper surface of the lower body member including an upper extension rail, the lower extension rail and the upper extension rail defining a longitudinal slot.

5. The wax wire apparatus of claim 4, wherein each wire side clip includes a central channel defined by a rear surface of the lower extension rail, a rear surface of the upper extension rail, a lower surface of the upper body member, and an upper surface of the lower body member.

6. The wax wire apparatus of claim 3, further including a first hook clip on the inner surface of one of the front wall, the right wall, the rear wall, and the left wall, wherein the vertical slicing wire loop is hooked over the first hook clip.

7. The wax wire apparatus of claim 1, further including a wire funnel on the inner surface of the right wall, and the horizontal wire loop is disposed through the wire funnel.

8. The wax wire apparatus of claim 1, further including a cross tie positioned on a floor surface of the wax container, the cross tie including at least one wire channel, the vertical slicing wire loop being disposed in the wire channel.

9. A wax wire apparatus comprising:
a wax container;
a horizontal slicing wire loop secured within the wax container, a portion of the horizontal slicing wire loop being disposed in a generally horizontal plane;
a vertical slicing wire loop secured within the wax container, a portion of the wire loop being disposed in a generally vertical plane; and
a mass of hardened wax within the wax container, the mass of hardened wax including a front surface, a right surface, a rear surface, a left surface, a bottom surface, and a top surface, a portion of the horizontal slicing wire loop being disposed around the front surface, right surface, rear surface and left surface, and a portion of the vertical slicing wire loop being disposed around the front surface, the top surface, the rear surface and the bottom surface.

10. The wax wire apparatus of claim 9, wherein the wax container includes a front wall, a right wall, a rear wall, a left wall, and a lower surface, and the wax wire apparatus further includes a first wire side clip on an inner surface of the front wall, a second wire side clip on an inner surface of the right wall, a third wire side clip on an inner surface of the rear wall, and a fourth wire side clip on an inner surface of the left wall, wherein the horizontal slicing wire loop is secured adjacent the inner surfaces of the front, right, rear and left walls by the first, second, third and fourth wire side clips.

11. The wax wire apparatus of claim 10, wherein each wire side clip includes an upper body member and a lower body member, a lower surface of the upper body member including a lower extension rail, an upper surface of the lower body member including an upper extension rail, the lower extension rail and the upper extension rail defining a longitudinal slot.

12. The wax wire apparatus of claim 11, wherein each wire side clip includes a central channel defined by a rear surface of the lower extension rail, a rear surface of the upper extension rail, a lower surface of the upper body member, and an upper surface of the lower body member.

13. The wax wire apparatus of claim 10, further including a first hook clip on the inner surface of one of the front wall, the right wall, the rear wall, and the left wall, wherein the vertical slicing wire loop is hooked over the first hook clip.

14. The wax wire apparatus of claim 9, further including a wire funnel on the inner surface of the right wall, and the horizontal wire loop is disposed through the wire funnel.

15. The wax wire apparatus of claim 9, further including a cross tie positioned on a floor surface of the wax container, the cross tie including at least one wire channel, the vertical slicing wire loop being disposed in the wire channel.

16. A wax wire apparatus comprising:
a wax container;
a lower horizontal slicing wire loop secured within the wax container, a portion of the lower horizontal slicing wire loop being disposed in a first generally horizontal plane;
an upper horizontal slicing wire loop secured within the wax container, a portion of the upper horizontal slicing wire loop being disposed in a second generally horizontal plane, the second generally horizontal plane being above and spaced apart from the first generally horizontal plane;
a front-to-back vertical slicing wire loop secured within the wax container, a portion of the front-to-back vertical slicing wire loop being disposed in a first generally vertical plane; and
a side-to-side vertical slicing wire loop secured within the wax container, a portion of the side-to-side vertical slicing wire loop being disposed in a second generally vertical plane.

17. The wax wire apparatus of claim 16, wherein the first generally vertical plane is generally perpendicular to the second generally vertical plane.

18. The wax wire apparatus of claim 16, further including a mass of hardened wax within the wax container, the mass of hardened wax including a front surface, a right surface, a rear surface, a left surface, a bottom surface, and a top surface, a portion of the upper horizontal slicing wire loop and the lower horizontal slicing wire loop being disposed around the front surface, right surface, rear surface and left surface, a portion of the front-to-back vertical slicing wire loop being disposed around the front surface, the top surface, the rear surface and the bottom surface, and a portion of the side-to-side vertical slicing wire loop being disposed around the left surface, the bottom surface, the right surface, and the top surface.

19. The wax wire apparatus of claim 16, further including an upper wire funnel and a lower wire funnel, the upper wire funnel being positioned on the inner surface of the right wall, the lower wire funnel being positioned on the inner surface of the right wall below the upper wire funnel, the upper horizontal slicing wire loop being disposed through the upper wire funnel, and the lower horizontal slicing wire loop being disposed through the lower wire funnel and the upper wire funnel.

20. The wax wire apparatus of claim 16, further including a first cross tie and a second cross tie, each of the first and second cross ties being positioned on a floor surface of the wax container and including a front-to-back wire channel and a side-to-side wire channel, the front-to-back vertical slicing wire loop being disposed in the front-to-back wire channel, and the side-to-side vertical slicing wire loop being disposed in the side-to-side wire channel.
